(19) United States
(12) Patent Application Publication
(10) Pub. No.: US 2004/0166209 A1
(43) Pub. Date: Aug. 26, 2004

(54) Chewable film containing cellulose

(76) Inventors: Herbert Gord, Ingelheim (DE); Klaus-Dieter Hammer, Mainz (DE); Rainer Neeff, Wiesbaden (DE); Klaus Berghof, Rudolstadt (DE); Markus Eilers, Wietmarschen-Lohne (DE); Eberhard Taeger, Weissbach (DE); Horst Buerger, Rudolstadt (DE)

Correspondence Address: CONNOLLY BOVE LODGE & HUTZ LLP, SUITE 800, 1990 M STREET NW, WASHINGTON, DC, 20036-3425, US

(21) Appl. No.: 10/481,182

(22) PCT Filed: Jun. 14, 2002
(86) PCT No.: PCT/EP02/06556

(30) Foreign Application Priority Data
Jun. 22, 2001 (DE) 101 29 539.1

(51) Int. Cl. A21D 13/00

(52) U.S. Cl. 426/138

(57) ABSTRACT

The invention relates to an edible packaging film for foodstuffs, which contains cellulose, at least one protein and at least one filler. Bran, ground natural fibres, cotton linters, chitosan, guar meal, carob meal or micro-crystalline cellulose are preferably used as the fillers. The film is predominantly used to produce synthetic sausage casings.

The invention relates to a packaging film for foods which is suitable for co-consumption, a process for production thereof, and use thereof.

Sausage skins which are suitable or intended for co-consumption which have been used to date are especially natural skins (for Bockwursts, especially sheep's intestines) and collagen skins. In the case of an edible collagen skin of caliber 21 the mechanical properties of importance for chewability are in the following ranges:

| | |
|---|---|
| Tear strength in the longitudinal | 20 to 40 N/mm² |
| direction in the dry state: | |
| Tear strength in the longitudinal | 5 to 10 N/mm² |
| direction in the wet state: | |
| Elongation at break in the longitudinal | 10 to 30% |
| direction in the dry state: | |
| Elongation at break in the longitudinal | 10 to 20% |
| direction in the wet state: | |
| Bursting pressure in the wet state: | 18 to 30 kPa |

It is of importance, therefore, that the tear strength in the wet state is lower than in the dry state.

However, because of animal diseases, such as BSE, there are strong reservations against the use of natural skins and collagen skins. However, the edible sausage casings based on calcium alginate (DE-C 12 13 211) which have been developed as a substitute have proved technically unsatisfactory. Owing to an interaction between the sausage meat emulsion and the brine, the slightly soluble calcium alginate is gradually converted into the more readily soluble sodium alginate. As a result the casings lose stability. Edible skins based on other natural polymers, such as crosslinked casing, likewise have not had widespread use.

Also known are biodegradable, if appropriate even edible, shaped bodies made of a thermoplastic mixture which comprises as essential constituents native or modified starch and protein (WO 93/19125). Starch and protein are bound together by a crosslinking agent, such as formaldehyde, glutaraldehyde or epichlorohydrin. The thermoplastic mixture can, in addition, also comprise plasticizers, lubricants, fillers, antimicrobial substances and/or colorings, such as glycerol, glycerol mono-, glycerol di- or glycerol triacetate, sorbitol, mannitol, ethylene glycol, polyvinyl alcohol, methyl cellulose, diethyl citrate, fatty acids, vegetable oil, mineral oil or microcrystalline cellulose. From the mixture, by deep-drawing, injection molding, blow molding or similar process, shaped bodies may be produced, for example films, capsules, dishes, bottles, pipes. For tubular food casings, in particular cooking-stable sausage casings, the thermoplastic mixture is less suitable, however, since starch dissolves at least in part in hot water. For an edible sausage casing the material moreover is too tough.

The production of fibers from proteins is also known. They may be obtained by dissolving the proteins and spinning the resultant solution directly into a coagulation bath (wet-spinning process) or into a climate-controlled drying shaft (dry-spinning process; see CH 232 342).

A process which has been of industrial importance in the past was the ®Lanital process for producing protein fibers from casein (GB 483 731; FR 813 427; U.S. Pat. No. 2,297,397; U.S. Pat. No. 2,338,916). In this process casein, which is in turn produced by acid precipitation from milk, is dissolved in dilute sodium hydroxide solution. The solution is then spun into a precipitation bath of dilute sulfuric acid. The resultant fibers or filaments are then hardened in a formaldehyde-containing bath. Apart from casein, other proteins may alternatively be used as raw material, for example corn, peanut, soybean, cotton seed or fish proteins. To harden the shaped protein bodies after coagulation, the polypeptide chains oriented by stretching are crosslinked and thus fixed. Suitable crosslinking agents, in addition to formaldehyde, are also other aldehydes or dialdehydes, and also formamide and aluminum sulfate.

Finally, a process is also known for producing concentrated solutions of fibrillar proteins in NMMO monohydrate and the use of the solution for producing shaped bodies (DE-A 198 41 649). However, the globular proteins which occur naturally in great number and can frequently be isolated in a simple manner cannot be used for this process.

A synthetic cellulose-based skin, again, is not chewable and therefore not suitable for co-consumption. However, it may be produced in a simple and an environmentally friendly manner by relatively recent processes, such as the amine oxide process, in contrast to the case with the viscose process which was customary earlier. In the amine oxide process the cellulose is dissolved in an amine oxide, in particular in N-methylmorpholine N-oxide (NMMO), without the cellulose becoming chemically modified. The amine oxide/cellulose solution may be spun on known apparatuses, for example using annular dies. After passing through an air gap, the extruded shaped body passes into an aqueous precipitation bath in which the cellulose is regenerated. There are numerous descriptions of such processes (U.S. Pat. No. 4,246,221, DE-A 42 19 658, DE-A 42 44 609, DE-A 43 43 100, DE-A 44 26 966).

The products which have been developed to date as a substitute for natural skins and collagen skins have not fulfilled the requirements to be made with respect to chewability and/or toxicological safety. The processes known to date for processing proteins are, in addition, associated with a great number of processing stages, which requires technically complex and correspondingly expensive installations.

It is an object of the present invention, therefore, to provide an edible, that is to say suitable for co-consumption, packaging film for foods which is physiologically and toxicologically safe, is readily chewable and also can still be produced simply and inexpensively without great environmental pollution. The raw materials for this are to be simply and cheaply available.

We have found that this object is achieved, surprisingly, by adding protein and filler to a solution of cellulose in NMMO monohydrate. This produces a mixture which, after extrusion and regeneration, leads to an edible film, that is to say primarily chewable film. The mechanical properties of the film differ markedly, surprisingly, from those of a pure cellulose film. The reason is presumed to be an interruption in the interactions between the stretched cellulose molecules (β-glucoside bond) given the inclusion of the protein molecules and filler particles.

The present application therefore relates to a packaging film for foods which is suitable for co-consumption, which is characterized in that the packaging film comprises cellulose, at least one protein and at least one filler. The film is preferably a seamless tubular film which can be used as a sausage casing.

To produce the inventive film, preferably a cellulose is used which has a degree of polymerization DP (determined by the cuoxam method, therefore also called cuoxam-DP) of from about 300 to 700, preferably from about 400 to 650. A sulfite pulp having a cuoxam-DP of from about 520 to 600 has proved to be particularly expedient. In contrast to the case in the known viscose process, the cellulose DP in the NMMO process is virtually not decreased. The cellulose content is generally from 20 to 70% by weight, preferably from 30 to 65% by weight, in each case based on the dry weight of the film.

The protein is preferably a natural globular protein, in particular casein (milk protein), soybean protein, gluten (wheat protein), zein (corn protein), ardein (peanut protein) or pea protein. In principle, any protein is suitable which is soluble together with the cellulose in NMMO monohydrate. The content of the at least one protein is generally from 5 to 50% by weight, preferably from 8 to 45% by weight, in each case based on the dry weight of the film, that is to say the weight of the water-free and glycerol-free film.

To decrease or eliminate the water solubility of the protein, it has proved to be expedient to crosslink the protein in advance. This may be achieved, for example, by reacting the protein with an aldehyde, methylol, epoxide and/or enzyme. The terms “aldehyde”, “methylol” etc. here include compounds having more than one carbaldehyde or methylol group. Thus particularly suitable crosslinkers are dimethylolethyleneurea and dialdehydes, in particular glyoxal, malonaldehyde, succinaldehyde and glutaraldehyde. The crosslinking is usually performed in the presence of Lewis acids; the temperature during the reaction is generally from 0 to 160° C. During the crosslinking, not only do the free amino groups and any acid amide groups of the protein present react, but also the imino groups of the peptide bonds and hydroxyl groups of the serine. An enzyme having crosslinking activities is, for example, transglutaminase. The content of crosslinker(s) is a function of its type. In general the content is from 0.5 to 5.0% by weight, preferably from 1.0 to 3.0% by weight, in each case based on the weight of the protein.

Crosslinking can also be performed subsequently. For example, a toxicologically safe crosslinking agent can be applied to the film in the last vat, together with the secondary plasticizer, this is generally glycerol. Preferred crosslinking agents are citral, tannin, sugar-dialdehyde, dialdehyde-starch, caramel and epoxidized linseed oil. The amount applied is controlled in such a manner that the film then comprises from about 0.5 to 5% by weight, based on its dry weight, of crosslinking agent. The actual crosslinking is then carried out during subsequent drying and storage of the film.

The fillers are to be as insoluble as possible in the NMMO spinning solution. Fillers insoluble in NMMO can be added early to the pulp before water is distilled off under reduced pressure. Fillers which have a certain solubility in NMMO are expediently not mixed with the spinning solution until immediately before extrusion. If required, the solubility of the fillers in NMMO monohydrate can be reduced by preliminary crosslinking. Like the proteins, the fillers interrupt the cellulose structure. They decrease the extensibility of the film without impairing its strength. Particularly suitable organic fillers are brans, for example wheat brans, ground natural fibers, in particular ground flax fibers, hemp fibers or cotton fibers, cotton linters, chitosan, guar seed meal, carob bean meal, or microcrystalline cellulose. Instead of the organic fillers, or additionally thereto, finely divided inorganic fillers can also be used. Examples of these are ground calcium carbonate or pulverulent SiO₂. Suitable fillers have a particle size less than 100 μm, preferably from 2 to 50 μm. The content of filler(s) is generally from 3 to 60% by weight, preferably from 4 to 50% by weight, in each case based on the dry weight of the film.

To be readily chewable, the film must not have a very high wet strength and must also not be very tough. The chewability may be further improved by adding hydrophilic additives. The hydrophilic additives are likewise soluble in the NMMO spinning solution. Those which are particularly suitable are homopolysaccharides and derivatives thereof (in particular esters and ethers), such as starch, starch acetate, chitin, chitosan or pectin; heteropolysaccharides and derivatives thereof, such as carrageenan, xanthan, alginic acid and alginates; finally, also, toxicologically safe synthetic polymers or copolymers, such as polyvinylpyrrolidone, polyvinyl alcohol or polyethylene oxides. The content of the hydrophilic additives is generally from about 0.5 to 15% by weight, preferably from 1 to 10% by weight, in each case based on the total weight of the film.

The film can be further modified with the aid of primary plasticizers or lubricants. These are, for example, triglycerides, waxes, such as schellac, hydrocarbons, such as edible natural rubbers, or paraffins.

Expediently, the film also comprises a secondary plasticizer, in particular glycerol. The secondary plasticizer is added, as is generally customary, in a plasticizer vat immediately before the film is dried.

The inventive film exhibits, wet, a tear strength (in longitudinal direction) of from 3 to 12 N/mm², preferably from 4 to 8 N/mm². In the dry state, the tear strength is significantly higher. It is then from about 15 to 50 N/mm², preferably from 20 to 45 N/mm². The elongation at break in the longitudinal direction is, in the dry state, from 12 to 30%, and in the wet state from about 10 to 20%. If the film is to be used as sausage casing, it is generally fabricated as seamless tubular film. The bursting pressure of the tubular film is generally from about 15 to 32 kPa.

Processes for producing non-edible tubular films using NMMO/water/cellulose spinning solutions, which may also comprise other modifying additives in dissolved form, are known in principle to those skilled in the art and are described, for example, in WO 97/31970.

In the process for producing the inventive casing, the cellulose and the optionally preliminarily crosslinked protein are dissolved in aqueous NMMO, the solution is mixed with the filler and the resultant suspension is extruded. To produce seamless tubular films, the suspension is extruded through an annular die. The extruded film is then transported into a coagulation bath (=spinning bath) which contains an aqueous NMMO solution (preferably an approximately 15% strength by weight aqueous NMMO solution). However, it is necessary also to take into account the fact that the film has only a very low load-bearing capacity in the wet state. The apparatuses which move the film through the individual production stages (spinning baths, wash vats, plasticizer vat, dryer etc.) must therefore operate in a particularly gentle manner. For this it is expedient to make all reversal rolls in the individual baths separately controllable in very fine gradations and additionally to reinforce the transport, for example by conveyor belts or hydraulic conveying tubes. After the film has passed through the spinning bath, it is further conducted through wash baths in which residues of NMMO are removed. Expediently, the film is then further conducted through a plasticizer vat which contains plasticizer (preferably glycerol). Because of the low stability of the wet tubular film, the customary drying in the inflated state cannot take place immediately. Not until the water content in the non-inflated gel tube has been reduced does the stability increase to the point that the final drying can be carried out in the inflated state. It has therefore proved expedient to dry the tubular film first in the non-inflated state using hot air. The substantially dewatered tubular film is then inflated to the intended final caliber and dried with hot air to the predetermined final moisture content. The final drying in the inflated state cannot be avoided. By means of the longitudinal and transverse stretching which take place in the course of this, important properties such as strength and caliber constancy, are first set. When the tubular film has passed through the dryer, it is generally wound up. It can then be further prepared for its end use, for example by being cut to size, shirred or the like.

In the ready-to-stuff state, the inventive tubular film generally has a moisture content of from 8 to 20% by weight, preferably from 10 to 18% by weight.

The inventive tubular film is used primarily as artificial sausage casing, in particular for small sausages, small Bratwurst sausages, and small-caliber scalded-emulsion and cooked-meat sausages.

The examples hereinafter serve to describe the invention. Percentages therein are percentages by weight, if not stated otherwise. In all of the example the wood pulp is a sulfite pulp MoDo Dissolving from MoDo having a cuoxam-DP of about 550 (examples 1 to 7), or about 500 (example 8). After the final drying, all casings had the caliber 21.

### EXAMPLE 1

7.45 kg of ground wood pulp were slurried in 130 kg of a solution of 60% NMMO and 40% water. By adding NaOH, a pH of 11 was set. 7.7 kg of moist casein (40% dry matter) were added to this slurry. A moist casein was obtained by acid precipitation from thermally pretreated (that is to say heated to above 70° C.) skimmed milk. To decrease the water solubility, the casein was preliminarily crosslinked with 3% glutaraldehyde, based on the weight of the casein. As stabilizer, in addition, 20 g of propyl gallate were added (the propyl gallate prevents decomposition of the NMMO). 3.5 kg of finely ground wheat bran of a particle size of from 40 to 60 μm were then stirred into the slurry.

With heating and stirring, water was then distilled off at a pressure of 25 mbar under increasing temperature until the solvent consisted of approximately 87% NMMO and 13% water (equivalent to NMMO monohydrate). The solution then had a refractive index of 1.4887 and a zero-shear viscosity of 2.910 Pa·s at 85° C.

The spinning solution thus prepared was extruded at a temperature of 90° C. through an annular die having an annulus diameter of 20 mm. The film tube first passed through an air section of 10 cm in length. In this it was kept free from creases by support air which was introduced into the interior of the tubular film. In the tube interior, in addition, as an internal precipitation bath, a continuously renewed 15% strength aqueous NMMO solution which was kept to a controlled 5° C. was introduced. The outer precipitation bath consisted of an aqueous NMMO solution of the same composition and temperature. The tube then passed through a precipitation bath section of 3 m, with it being reversed after passing through half the distance. On leaving the spinning vat, the tube was transversely stretched to the point that its flat width was 30 mm.

The tube then passed through 4 wash vats each having 8 reversal rolls at the top and the bottom, a bath depth of 2.5 m, and an air section of 0.5 m. At the end of the last vat, water was introduced which was conducted in countercurrent flow. At the exit of the first vat, the NMMO content was kept in this manner at from 12 to 16%. The temperature increased from one vat to the next up to from 60 to 70° C. in the last vat. Finally, the tube was conducted through a plasticizer vat which contained a 10% strength aqueous glycerol solution kept at a controlled 60° C. On leaving the glycerol vat, the flat width of the tube was still 20 mm. The tube was then preliminarily dried in a nozzle dryer in the non-inflated state floating horizontally. It was then dried using hot air in the inflated state between 2 pinch-roll pairs. The dryer comprised several zones with increasing temperature. The zone at the dryer inlet had a temperature in this case of 120° C., and that at the outlet of 80° C. After passing through the dryer, the tubular film was moistened to a water content of from 8 to 12%, based on the total weight of the tube. The mechanical properties of the tube are summarized in the table hereinafter.

The tube was then further moistened until it had a water content of from 16 to 18%, based on its total weight, and then shirred to form shirred sticks. The shirred sticks were stuffed with sausage meat emulsion on an automatic stuffing machine (®FrankAMatic), scalded and smoked. The casing was readily chewable and comminutable.

### EXAMPLE 2

Example 1 was repeated except that the plasticizer vat then, in addition to glycerol, also contained a crosslinking agent (dialdehyde-starch). The crosslinking occurred during drying. The subsequent preparation for end use and processing were performed as described in example 1.

### EXAMPLE 3

7.45 kg of ground wood pulp were slurried in 130 kg of a 60% strength aqueous NMMO solution. A pH of 11 was set by adding NaOH. This slurry was admixed with 3.3 kg of commercially conventional zein. The stabilizer used was, in addition, 20 g of propyl gallate. 5.3 kg of finely ground wheat bran was then mixed with the slurry.

Further process steps were as described in example 1.

### EXAMPLE 4

5.3 kg of ground wood pulp were slurried in 130 kg of a 60% strength aqueous NMMO solution. A pH of 11 was set by adding NaOH. To this slurry were then added 2.2 kg of commercially conventional zein. As filler, 3 kg of finely ground wheat bran were stirred into the slurry. The stabilizer added was, in addition, 20 g of propyl gallate.

With heating and stirring, at a pressure of 25 mbar, with increasing temperature, water was then distilled off until the solvent consisted of 87% NMMO (equivalent to NMMO monohydrate). The solution had a refractive index 1.4850 and a zero-shear viscosity of 1.090 Pa·s at 85° C.

Further steps for producing the tubular film were as described in example 1.

### EXAMPLE 5

6.3 kg of ground wood pulp were slurried in 130 kg of a 60% strength aqueous NMMO solution. A pH of 11 was set by adding NaOH. This slurry was admixed with 2.2 kg of commercially conventional zein. As fillers, 2 kg of short cotton fibers crosslinked with citric acid were added. As stabilizer, in addition, 20 g of propyl gallate were added.

Under heating and stirring, then at a pressure of 25 mbar with increasing temperature, water was distilled off until the content of NMMO in the solvent was 87% (equivalent to NMMO monohydrate). The solution had a refractive index of 1.4840 and a zero-shear viscosity of 1.450 Pa·s at 85° C.

Spinning, washing, drying, preparation for end-use, and processing were performed as described in example 1.

### EXAMPLE 6

6.3 kg of ground wood pulp were slurried in 130 kg of a 60% strength aqueous NMMO solution. A pH of 11 was set by adding NaOH. This slurry was admixed with 2.2 kg of commercially conventional zein. As fillers, 1 kg of each of short cotton fibers and ground wheat bran were stirred into the slurry. As stabilizer, in addition, 20 g of propyl gallate were added.

Under heating and stirring, then at a pressure of 25 mbar with increasing temperature, water was distilled off until the content of NMMO in the solvent was 87%. The solution had a refractive index of 1.4860 and a zero-shear viscosity of 1.520 Pa·s at 85° C.

Spinning, washing, drying, preparation for end-use, and processing were performed as described in example 1.

### EXAMPLE 7

6.3 kg of ground wood pulp were slurried in 130 kg of a 60% strength aqueous NMMO solution. The pH was set to 11 by adding NaOH. To the slurry were then added 3.8 kg of commercially conventional ardein (=peanut protein). In addition, 1.0 kg of finely ground wheat bran and 0.5 kg of native potato starch were added. As stabilizer, in addition, 20 g of propyl gallate were added.

Under heating and stirring, then, at a pressure of 25 mbar and with increasing temperature, water was distilled off until the content of NMMO in the solvent was 87%. The solution had a refractive index of 1.4870 and a zero-shear viscosity of 1.830 Pa·s at 85° C.

Spinning, washing, drying, preparation for end-use and processing were performed as described in example 1.

### EXAMPLE 8

5.1 kg of ground wood pulp were slurried in 136 kg of a 60% strength aqueous NMMO solution. A pH of 11 was then set by adding NaOH. To this slurry were then added 1.3 kg of dry casein. To reduce the water solubility, the casein had been crosslinked using 0.03% transglutaminase and 4% glutaraldehyde, in each case based on the weight of the casein. As filler, 6 kg of finely ground wheat bran were stirred into the slurry. In addition, 20 g of propyl gallate were added as stabilizer.

Under heating and stirring, then, at a pressure of 25 mbar with increasing temperature, water was distilled off until the NMMO content in the solvent was 87% (equivalent to NMMO monohydrate). The solution had a refractive index of 1.4883 and a zero-shear viscosity of 1.300 Pa·s at 85° C. Spinning, washing, drying, preparation for end-use and processing were then performed as described in example 1.

TABLE

| | |
|---|---|
| Tear | |
| strength/ | Elongation/ |
| longitudinal | longitudinal |
| [N/mm^{2]} | [%] |

| Example | Dry | Wet | Dry | Wet |
|---|---|---|---|---|
| Comparison* | 31 | 6 | 13 | 16 |
| Collagen | | | | |
| 1 | 15 | 4 | 20 | 12 |
| 2 | 17 | 6 | 18 | 18 |
| 3 | 16 | 7 | 22 | 20 |
| 4 | 15 | 4 | 13 | 9 |
| 5 | 22 | 8 | 18 | 15 |
| 6 | 33 | 7 | 15 | 14 |
| 7 | 15 | 4 | 19 | 18 |
| 8 | 16 | 7 | 21 | 14 |

1. A packaging film for food which is suitable for co-consumption, and which comprises cellulose, at least one protein and at least one filler.

2. The packaging film as claimed in claim 1, wherein the cellulose has a degree of polymerization DP (determined by the cuoxam method) of from about 300 to 700, preferably from about 400 to 650.

3. The packaging film as claimed in claim 1 or 2, wherein the cellulose content is from 20 to 70% by weight, preferably from 30 to 65% by weight, in each case based on the dry weight of the film.

4. The packaging film as claimed in one or more of claims 1 to 3, wherein the protein is a natural globular protein, preferably casein, soybean protein, gluten, zein, ardein or pea protein.

5. The packaging film as claimed in one or more of claims 1 to 4, wherein the content of the at least one protein is from 5 to 50% by weight, preferably from 8 to 45% by weight, in each case based on the dry weight of the film.

6. The packaging film as claimed in one or more of claims 1 to 5, wherein the protein is preliminarily crosslinked.

7. The packaging film as claimed in claim 6, wherein the preliminary crosslinking of the protein is performed by reaction with an aldehyde, methylol, epoxide and/or enzyme.

8. The packaging film as claimed in claim 7, wherein the content of crosslinker(s) is from 0.5 to 5.0% by weight, preferably from 1.0to 3.0% by weight, in each case based on the weight of the protein.

9. The packaging film as claimed in one or more of claims 1 to 8, wherein the filler is an organic filler, preferably bran, ground natural fibers, cotton linters, chitosan, guar seed meal, carob bean meal or microcrystalline cellulose.

10. The packaging film as claimed in one or more of claims 1 to 8, wherein the filler is an inorganic filler, preferably ground calcium carbonate or pulverulent SiO₂.

11. The packaging film as claimed in one or more of claims 1 to 10, wherein the content of filler(s) is from 3 to 60% by weight, preferably from 4 to 50% by weight, in each case based on the dry weight of the film.

12. The packaging film as claimed in one or more of claims 1 to 11, wherein it comprises a hydrophilic additive which is soluble in the spinning solution.

13. The packaging film as claimed in claim 12, wherein the hydrophilic additive is a homopolysaccharide or a derivative thereof, preferably starch, starch acetate, chitin, chitosan or pectin, a heteropolysaccharide or a derivative thereof, preferably carrageenan, xanthan, alginic acid or alginates, a toxicologically safe synthetic polymer or copolymer, preferably polyvinylpyrrolidone, polyvinyl alcohol or a polyethylene oxide.

14. The packaging film as claimed in claim 12 or 13, wherein the content of hydrophilic additive(s) is from 0.5 to 15% by weight, preferably from 1 to 10% by weight, in each case based on the dry weight of the film.

15. The packaging film as claimed in one or more of claims 1 to 14, wherein it comprises a primary plasticizer and/or a lubricant.

16. The packaging film as claimed in one or more of claims 1 to 15, wherein it has, wet, a tear strength of from 3 to 12 N/mm², preferably from 4 to 8 N/mm², and, dry, a tear strength of from about 15 to 50 N/mm², preferably from 20 to 45 N/mm².

17. The packaging film as claimed in one or more of claims 1 to 16, wherein it has the form of a seamless tube.

18. The use of the packaging film as claimed in one or more of claims 1 to 17 as artificial sausage casing, preferably for small sausages, Bratwurst small sausages and small-caliber scalded-emulsion sausages and cooked-meat sausages.
